(19) United States
(12) Patent Application Publication
(10) Pub. No.: US 2016/0290591 A1
(43) Pub. Date: Oct. 6, 2016

(54) EFFICIENT HEAT-DISSIPATING AND ALL DAY LIGHTING HEADLIGHT

(71) Applicant: YUJING TECHNOLOGY CO., LTD., NEW TAIPEI CITY (TW)

(72) Inventor: CHENG-FENG HUANG, NEW TAIPEI CITY (TW)

(73) Assignee: YUJING TECHNOLOGY CO., LTD.

(21) Appl. No.: 14/672,670

(22) Filed: Mar. 30, 2015

(51) Int. Cl. F21S 8/10

(52) U.S. Cl. CPC F21S 48/328; F21S 48/1747; F21S 48/115; F21Y 2101/02

(57) ABSTRACT

An efficient heat-dissipating and all day lighting headlight includes an inner heat-dissipating base, an outer heat-dissipating base, a circuit assembly, a low-beam lamp assembly, a high-beam lamp assembly, a daytime lamp assembly and a headlight cover. The inner heat-dissipating base has two opposite surfaces with one of the surfaces thermally contacting the circuit assembly and the outer heat-dissipating base. The circuit assembly is mounted between the inner heat-dissipating base and the outer heat-dissipating base. The low-beam, high-beam and daytime lamp assemblies thermally contact the other surface of the inner heat-dissipating base. The low-beam and high-beam assemblies are electrically connected to the circuit assembly. The daytime, low-beam and high-beam lamp assemblies are further covered by the headlight cover capable of radiating heat out. Given the inner heat-dissipating base and the daytime lamp assembly, the headlight has efficient heat dissipation, prolonged operation durability, and higher daytime driving safety.

### BACKGROUND OF THE INVENTION

1. Field of the Invention

The present invention relates to a headlight, and more particularly, to an efficient heat-dissipating and all day lighting headlight for daytime use.

2. Description of the Related Art

With reference to FIG. 6, a conventional headlight with high beam and low beam includes a reflector 81, a heat-dissipating base 82, a control circuit 83, a low-beam lamp 84, a high-beam lamp 85 and a transparent cover 86. The reflector 81 is cup-shaped and has a convex surface and a concave surface. One of two opposite surfaces of the heat-dissipating base 82 is in thermal contact with the convex surface of the reflector 81, and the other surface of the heat-dissipating base 82 is in thermal contact with the control circuit 83. The low-beam lamp 84 and the high-beam lamp 85 are mounted on the concave surface of the reflector 81 and are electrically connected to the control circuit 83. The low-beam lamp 84 is positioned above the high-beam lamp 85 for light emitted from the low-beam lamp 84 to be reflected by the reflector 81 and focused into a beam along a direction below the horizontal direction, thereby achieving a short-distance lighting effect. The high-beam lamp 85 is positioned at a focal point of the concave surface, such that light emitted from the high-beam lamp 85 is reflected by the reflector 81 and is focused into a beam along the horizontal direction to achieve a long-distance lighting effect. The low-beam lamp 84 and the high-beam lamp 85 can be alternatively switched for the purpose of short-distance lighting and long-distance lighting.

However, as the low-beam lamp 84 and the high-beam lamp 85 are mounted on the concave surface of the reflector 81 and the heat-dissipating base 82 is not efficient in rapidly dissipating the heat conducted thereto, the heat generated by the low-beam lamp 84 and the high-beam lamp 85 can be transferred outside the low-beam lamp 84 and the high-beam lamp 85 by the radiation, which is slow and inefficient. Accumulated high heat through a long period of time can shorten the life duration of the headlight. Furthermore, as daytime lighting gradually becomes a trend, daytime running lights (DRL) become mandatory equipment in certain countries, such as the members of the European Union (EU). Since the DRL is absent from the conventional headlight, the daytime lighting equipment must be additionally mounted to the conventional headlight to abide by the law and extra effort and difficulty arise from the addition.

### SUMMARY OF THE INVENTION

An objective of the present invention is to provide an efficient heat-dissipating and all day lighting headlight with efficient heat dissipation, prolonged operation durability, and enhanced daytime driving safety and mounting convenience.

To achieve the foregoing objective, the efficient heat-dissipating and all day lighting headlight includes an inner heat-dissipating base, an outer heat-dissipating base, a circuit assembly, a low-beam lamp assembly, a high-beam lamp assembly, a daytime lamp assembly, and a headlight cover.

The inner heat-dissipating base has a concave surface and a convex surface opposite to the concave surface.

The outer heat-dissipating base is in thermal contact with the convex surface of the inner heat-dissipating base and has a circuit chamber defined between the outer heat-dissipating base and the convex surface of the inner heat-dissipating base.

The circuit assembly is mounted inside the circuit chamber and is in thermal contact with the convex surface of the inner heat-dissipating base.

The low-beam lamp assembly is mounted inside the inner heat-dissipating base, is in thermal contact with the concave surface of the inner heat-dissipating base, and is electrically connected to the circuit assembly.

The high-beam lamp assembly is mounted inside the inner heat-dissipating base, is in thermal contact with the concave surface of the inner heat-dissipating base, and is electrically connected to the circuit assembly.

The daytime lamp assembly is mounted inside the inner heat-dissipating base, and is in thermal contact with the concave surface of the inner heat-dissipating base.

The headlight cover is coupled with the outer heat-dissipating base and covers the low-beam lamp assembly, the high-beam lamp assembly, and the daytime lamp assembly inside the inner heat-dissipating base.

When the efficient heat-dissipating and all day lighting headlight is turned on, the low-beam lamp assembly and the high-beam lamp assembly are turned on or off through the circuit assembly, and heat generated by the low-beam lamp assembly, the high-beam lamp assembly, the daytime lamp assembly, and the circuit assembly can be rapidly absorbed by the inner heat-dissipating base, conducted to the outer heat-dissipating base, and further radiated to the ambient air, thereby effectively enhancing the heat-dissipating efficiency of the entire headlight and prolonging the operation duration of the headlight. Additionally, the headlight further includes the daytime lamp assembly to endow all day lighting capabilities in collaboration with the low-beam lamp assembly and the high-beam lamp assembly. Unlike conventional headlights, an integral structural design of the present invention allows users to meet the daytime lighting requirement without having to additionally mount a daytime light. Accordingly, mounting convenience and daytime driving safety can be ensured when the present invention is mounted on a vehicle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an efficient heat-dissipating and all day lighting headlight in accordance with the present invention;

FIG. 2 is an exploded perspective view of the efficient heat-dissipating and all day lighting headlight in FIG. 1;

FIG. 3 is a cross-sectional side view of the efficient heat-dissipating and all day lighting headlight in FIG. 1;

FIG. 4 is another perspective view of the efficient heat-dissipating and all day lighting headlight in FIG. 1;

FIG. 5 is an operational side view of the efficient heat-dissipating and all day lighting headlight in FIG. 1 mounted in a vehicle; and

FIG. 6 is a schematic side view in partial section of a conventional headlight with high beam and low beam.

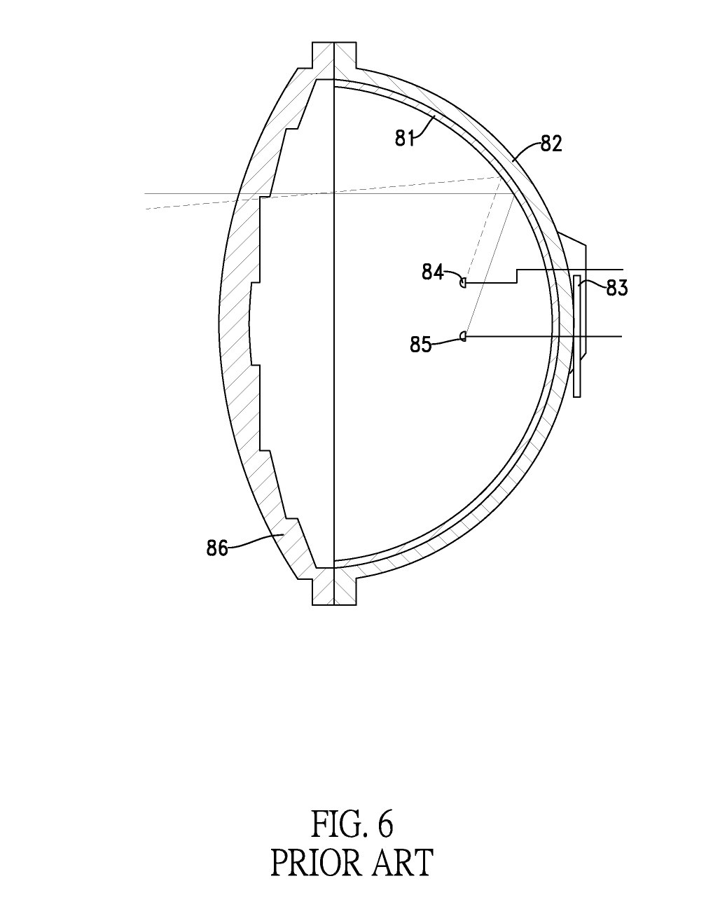

### DETAILED DESCRIPTION OF THE INVENTION

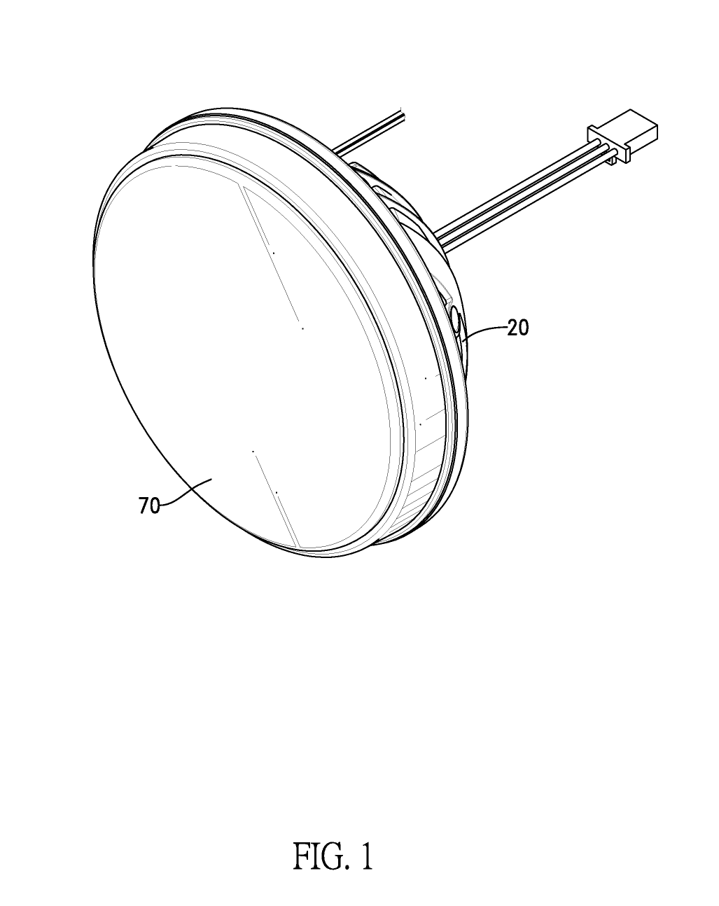

With reference to FIGS. 1 to 3, an efficient heat-dissipating and all day lighting headlight in accordance with the present invention includes an inner heat-dissipating base 10, an outer heat-dissipating base 20, a circuit assembly 30, a low-beam lamp assembly 40, a high-beam lamp assembly 50, a daytime lamp assembly 60, and a headlight cover 70.

The inner heat-dissipating base 10 has a concave surface 11, a convex surface 12, a first support plate 13, and a second support plate 14. The concave surface 11 and the convex surface 12 are opposite to each other. In the present embodiment, the inner heat-dissipating base 10 is made of a metal material with a good heat absorption rate and heat transfer speed. The first support plate 13 is formed on an edge portion of the concave surface 11. The second support plate 14 is formed on a nonperimetric portion of the concave surface 11, and is parallel to the first support plate 13. The low-beam lamp assembly 40 is mounted on the concave surface 11 and located between the first support plate 13 and the second support plate 14. The high-beam lamp assembly 50 is mounted on a portion of the concave surface 11 under the second support plate 14.

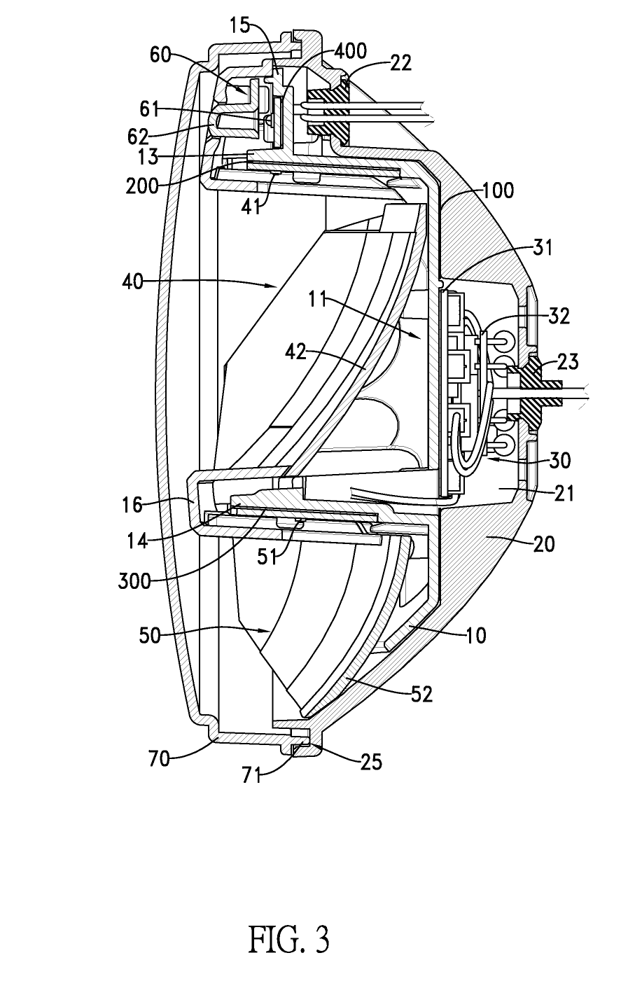

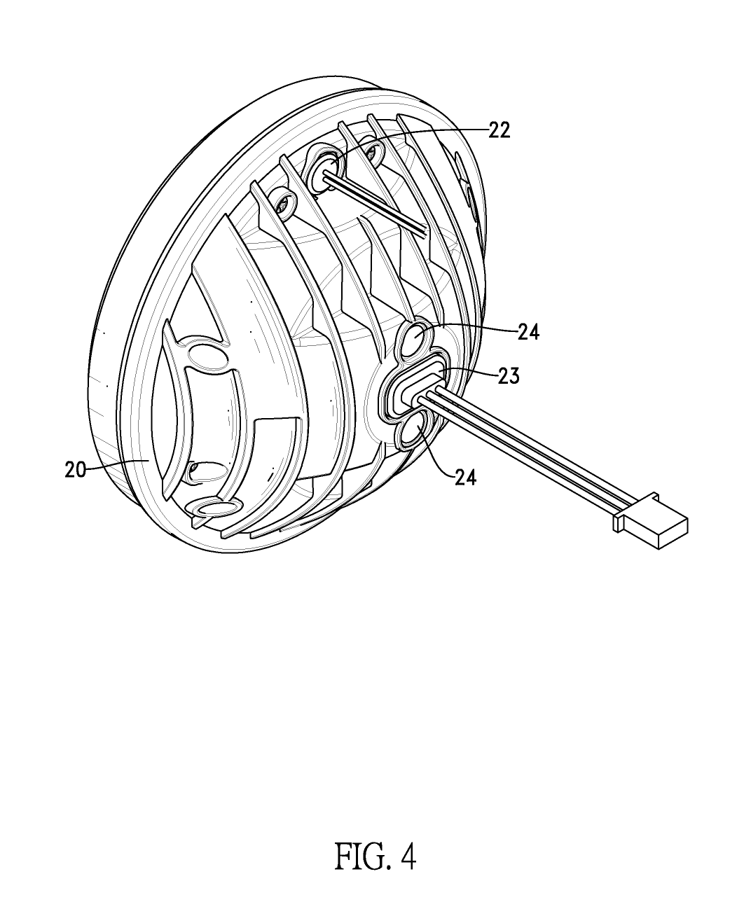

The outer heat-dissipating base 20 is mounted on and is in thermal contact with the convex surface 12 of the inner heat-dissipating base 10 to conduct heat generated by the inner heat-dissipating base 10 and further radiate the heat into air external to the outer heat-dissipating base 20. In the present embodiment, the outer heat-dissipating base 20 is made of a metal material. The outer heat-dissipating base 20 has a circuit chamber 21, a first plug 22, a second plug 23, and two permeable adhesive pads 24. The circuit chamber 21 is defined between the outer heat-dissipating base 20 and the convex surface 12 of the inner heat-dissipating base 10 to receive the circuit assembly 30. With reference to FIGS. 3 and 4, the first plug 21, the second plug 23, and the permeable adhesive pads 24 are mounted on a surface of the outer heat-dissipating base 20 opposite to a surface of the outer heat-dissipating base 20 that is in thermal contact with the inner heat-dissipating base 10. The first plug 22 is tightly inserted into a portion of the outer heat-dissipating base 20 that corresponds to the first support plate 13 and is adjacent to an edge portion of the outer heat-dissipating base 20. The second plug 23 is tightly inserted into a portion of the outer heat-dissipating base 20 that corresponds to the circuit chamber 21 with at least one electrical cable mounted through the second plug 23 for the circuit assembly 30 in the circuit chamber 21 to acquire external power. The two permeable adhesive pads 24 are respectively attached on two portions of an external surface of the outer heat-dissipating base 20 above and below the second plug 23, and are selectively removed for air circulation between the circuit chamber 21 and an ambient space external to the outer heat-dissipating base 20.

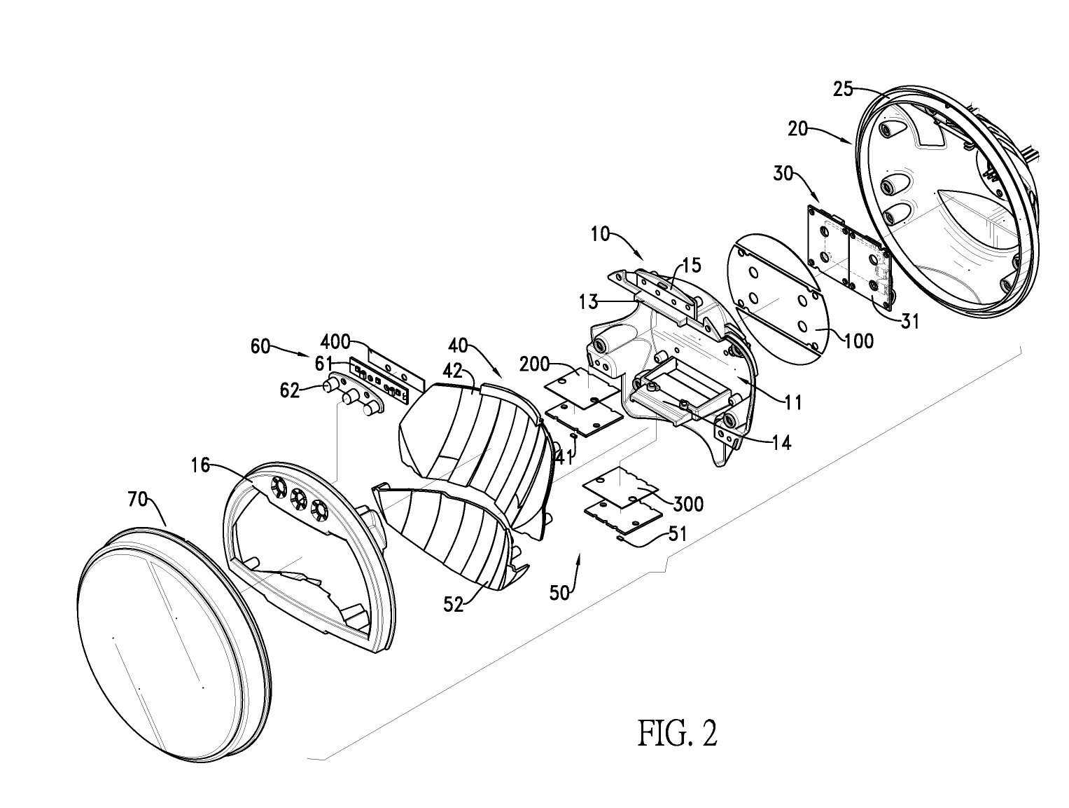

With reference to FIGS. 2 and 3, a first heat-dissipating pad 100 is bonded to and in thermal contact with the convex surface 12 of the inner heat-dissipating base 10. In the present embodiment, the circuit assembly 30 includes two control boards 31 and a resistor board 32.

The low-beam lamp assembly 40 is mounted inside the inner heat-dissipating base 10, is in thermal contact with the inner heat-dissipating base 10 through a second heat-dissipating pad 200, and is electrically connected to the circuit assembly 30. In the present embodiment, the low-beam lamp assembly 40 has a first luminaire 41 and a low-beam reflector 42. The first luminaire 41 is a light-emitting diode (LED) and is mounted on the first support plate 13 of the inner heat-dissipating base 10 to face and emit light toward the second support plate 14. The low-beam reflector 42 is arc-shaped, is mounted on a portion of the concave surface 11 between the first support plate 13 and the second support plate 14, and forms a tilting angle between the low-beam reflector 42 and the concave surface 11 for reflecting light emitted from the first luminaire 41 and focusing the reflected light into a beam projected in a direction away from the inner heat-dissipating base 10 with an included angle between the beam and a horizontal direction for the purpose of short-distance lighting.

The high-beam lamp assembly 50 is mounted inside the inner heat-dissipating base 10, is in thermal contact with the inner heat-dissipating base 10 through a third heat-dissipating pad 300, and is electrically connected to the circuit assembly 30. In the present embodiment, the high-beam lamp assembly 50 has a second luminaire 51 and a high-beam reflector 52. The second luminaire 51 is a light-emitting diode (LED) and is mounted on a surface of the second support plate 14 of the inner heat-dissipating base 10 to be opposite to the first support plate 13 and emit light in a direction away from the first support plate 13. The high-beam reflector 52 is arc-shaped, is mounted on a portion of the concave surface 11 under the second support plate 14, and forms a tilting angle between the high-beam reflector 52 and the concave surface 11 for reflecting light emitted from the second luminaire 51 and focusing the reflected light into a beam projected in a direction departing from the inner heat-dissipating base 10 and parallel to the horizontal direction for the purpose of long-distance lighting.

The daytime lamp assembly 60 is mounted inside the inner heat-dissipating base 10 and is in thermal contact with the inner heat-dissipating base 10 through a fourth heat-dissipating pad 400. In the present embodiment, a third support plate 15 is formed on a top surface of the first support plate 13 opposite to the second support plate 14, and is aligned with the first plug 22 of the outer heat-dissipating base 20. The daytime lamp assembly 60 has multiple third luminaires 61 and multiple transparent bosses 62. The multiple third luminaires 61 are mounted on the third support plate 15 and are in thermal contact with the third support plate 15. Each third luminaire 61 is an LED. Each third luminaire 61 acquires power from a power source external to the outer heat-dissipating base 20 through at least one electrical wire mounted through the first plug 22. Each transparent boss 62 is mounted on the daytime lamp assembly 60 and is aligned with one of the multiple third luminaires 61 for light emitted from the third luminaire 61 to penetrate through the transparent boss 62 in generation of a light beam.

The efficient heat-dissipating and all day lighting headlight further has a decorative frame 16 mounted on the first support plate 13, the second support plate 14 and the third support plate 15 with the low-beam lamp assembly 40, the high-beam lamp assembly 50 and the daytime lamp assembly 60 exposed.

The headlight cover 70 is coupled with the outer heat-dissipating base 20 and covers the low-beam lamp assembly 40, the high-beam lamp assembly 50, and the daytime lamp assembly 60 inside the inner heat-dissipating base 10. The headlight cover 70 protects the low-beam lamp assembly 40, the high-beam lamp assembly 50, and the daytime lamp assembly 60 against direct access thereto. In the present embodiment, the headlight cover 70 is made of a transparent material, such as glass, acrylic, and the like. The headlight cover 70 has an annular insert formed around an annular edge portion thereof to correspond to and engage an annular recess 25 formed in an annular edge portion of the outer heat-dissipating base 20 for the headlight cover 70 to be securely mounted on the outer heat-dissipating base 20.

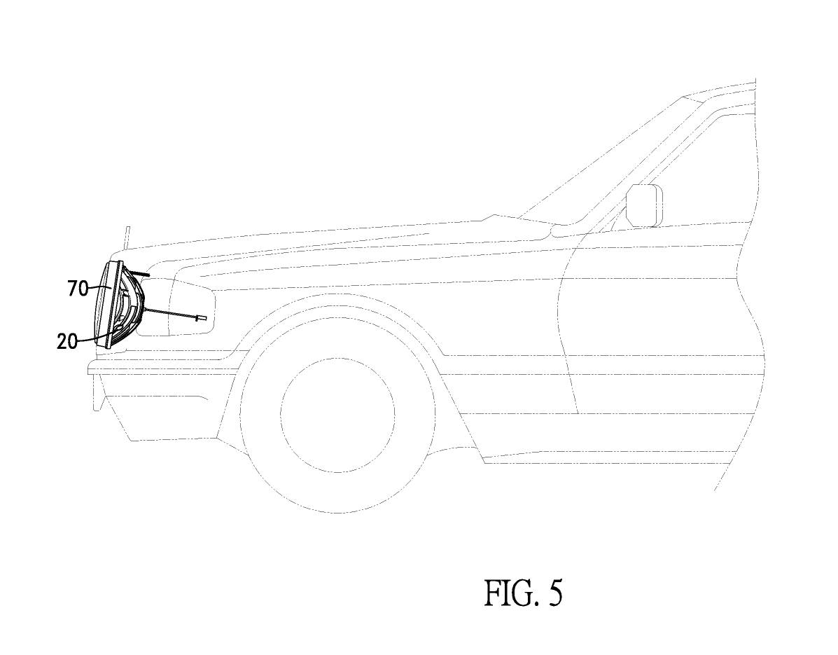

With reference to FIG. 5, when the efficient heat-dissipating and all day lighting headlight is operated, the on and off states of the low-beam lamp assembly 40, the high-beam lamp assembly 50, and the daytime lamp assembly 60 can be selectively switched, and heat generated when the low-beam lamp assembly 40, the high-beam lamp assembly 50, and the daytime lamp assembly 60 can be rapidly absorbed by the first support plate 13, the second support plate 14, and the third support plate 15, conducted to the outer heat-dissipating base 20, and radiated to the air external to the headlight, thereby effectively enhancing the heat-dissipating efficiency of the entire headlight and prolonging the operation duration of the headlight. Additionally, the efficient heat-dissipating and all day lighting headlight also incorporates the daytime lamp assembly 60 therein, rendering all day lighting to the headlight. In contrast to conventional headlights, the integral design gets rid of a daytime light additionally mounted on a part of a vehicle external to the headlight to meet the demand of daytime lighting. Accordingly, the efficient heat-dissipating and all day lighting headlight can be mounted in a convenient manner and also takes safety of daytime activities into account.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An efficient heat-dissipating and all day lighting headlight, comprising:
an inner heat-dissipating base having a concave surface and a convex surface opposite to the concave surface;
an outer heat-dissipating base being in thermal contact with the convex surface of the inner heat-dissipating base and having a circuit chamber defined between the outer heat-dissipating base and the convex surface of the inner heat-dissipating base;
a circuit assembly mounted inside the circuit chamber and being in thermal contact with the convex surface of the inner heat-dissipating base;
a low-beam lamp assembly mounted inside the inner heat-dissipating base, being in thermal contact with the concave surface of the inner heat-dissipating base, and electrically connected to the circuit assembly;
a high-beam lamp assembly mounted inside the inner heat-dissipating base, being in thermal contact with the concave surface of the inner heat-dissipating base, and electrically connected to the circuit assembly;
a daytime lamp assembly mounted inside the inner heat-dissipating base, and being in thermal contact with the concave surface of the inner heat-dissipating base; and
a headlight cover coupled with the outer heat-dissipating base and covering the low-beam lamp assembly, the high-beam lamp assembly, and the daytime lamp assembly inside the inner heat-dissipating base.

2. The efficient heat-dissipating and all day lighting headlight as claimed in claim 1, wherein the inner heat-dissipating base further has:
a first support plate formed on an edge portion of the concave surface of the inner heat-dissipating base; and
a second support plate formed on a nonperimetric portion of the concave surface of the inner heat-dissipating base, and being parallel to the first support plate;
wherein the low-beam lamp assembly is mounted on a portion of the concave surface between the first support plate and the second support plate, and the high-beam lamp assembly is mounted on another portion of the concave surface under the second support plate.

3. The efficient heat-dissipating and all day lighting headlight as claimed in claim 2, wherein the low-beam lamp assembly has:
a first luminaire being a light-emitting diode (LED) and mounted on the first support plate of the inner heat-dissipating base to face and emit light toward the second support plate; and
a low-beam reflector mounted on the portion of the concave surface between the first support plate and the second support plate, and forming a tilting angle between the low-beam reflector and the concave surface for reflecting light emitted from the first luminaire and focusing the reflected light into a beam projected in a direction away from the inner heat-dissipating base with an included angle between the beam and a horizontal direction.

4. The efficient heat-dissipating and all day lighting headlight as claimed in claim 3, wherein the high-beam lamp assembly has:
a second luminaire being an LED and mounted on a surface of the second support plate of the inner heat-dissipating base to be opposite to the first support plate and emitting light in a direction away from the first support plate; and
a high-beam reflector mounted on the portion of the concave surface under the second support plate, and forming a tilting angle between the high-beam reflector and the concave surface for reflecting light emitted from the second luminaire and focusing the reflected light into a beam projected in a direction departing from the inner heat-dissipating base and parallel to the horizontal direction.

5. The efficient heat-dissipating and all day lighting headlight as claimed in claim 4, wherein the outer heat-dissipating base further has a first plug, a second plug, and two permeable adhesive pads mounted on a surface of the outer heat-dissipating base opposite to a surface of the outer heat-dissipating base that is in thermal contact with the inner heat-dissipating base, the first plug is tightly inserted into a portion of the outer heat-dissipating base that corresponds to the first support plate and is adjacent to an edge portion of the outer heat-dissipating base, the second plug is tightly inserted into a portion of the outer heat-dissipating base that corresponds to the circuit chamber with at least one electrical cable mounted through the second plug for the circuit assembly in the circuit chamber to acquire external power, and the two permeable adhesive pads are respectively attached on two portions of an external surface of the outer heat-dissipating base above and below the second plug, and are selectively removed for air circulation between the circuit chamber and an ambient space external to the outer heat-dissipating base.

6. The efficient heat-dissipating and all day lighting headlight as claimed in claim 5, wherein
the inner heat-dissipating base further has a third support plate formed on a top surface of the first support plate opposite to the second support plate and aligned with the first plug of the outer heat-dissipating base;
the daytime lamp assembly has:
multiple third luminaires mounted on the third support plate and being in thermal contact with the third support plate, each third luminaire being an LED and acquiring power from a power source external to the outer heat-dissipating base through at least one electrical wire mounted through the first plug; and
multiple transparent bosses, each transparent boss mounted on the daytime lamp assembly and aligned with one of the multiple third luminaires for light emitted from the third luminaire to penetrate through the transparent boss in generation of a light beam.

7. The efficient heat-dissipating and all day lighting headlight as claimed in claim 6, wherein
the inner heat-dissipating base further has a third support plate formed on a top surface of the first support plate opposite to the second support plate and aligned with the first plug of the outer heat-dissipating base;
the daytime lamp assembly has:
multiple third luminaires mounted on the third support plate and being in thermal contact with the third support plate, each third luminaire being an LED and acquiring power from a power source external to the outer heat-dissipating base through at least one electrical wire mounted through the first plug; and
multiple transparent bosses, each transparent boss mounted on the daytime lamp assembly and aligned with one of the multiple third luminaires for light emitted from the third luminaire to penetrate through the transparent boss in generation of a light beam.

8. The efficient heat-dissipating and all day lighting headlight as claimed in claim 6, wherein the headlight cover has an annular insert formed around an annular edge portion thereof to correspond to and engage an annular recess formed in an annular edge portion of the outer heat-dissipating base for the headlight cover to be securely mounted on the outer heat-dissipating base.

9. The efficient heat-dissipating and all day lighting headlight as claimed in claim 8, wherein the efficient heat-dissipating and all day lighting headlight further has a decorative frame mounted on the first support plate, the second support plate and the third support plate with the low-beam lamp assembly, the high-beam lamp assembly and the daytime lamp assembly exposed.
